(19) United States
(12) Patent Application Publication
(10) Pub. No.: US 2010/0134722 A1
(43) Pub. Date: Jun. 3, 2010

(54) BACKLIGHT MODULE AND DISPLAY DEVICE USING THE SAME

(75) Inventors: Kun-Feng HUANG, Tainan County (TW); Mei-Ying CHEN, Tainan County (TW); Kuan-Li LIN, Tainan County (TW)

Correspondence Address: LOWE HAUPTMAN HAM & BERNER, LLP, 1700 DIAGONAL ROAD, SUITE 300, ALEXANDRIA, VA, 22314, US

(73) Assignee: CHI MEI OPTOELECTRONICS CORP., Tainan County (TW)

(21) Appl. No.: 12/629,163

(22) Filed: Dec. 2, 2009

(30) Foreign Application Priority Data
Dec. 2, 2008 (TW) 97146820

(51) Int. Cl. G02F 1/13357; F21V 7/04

(52) U.S. Cl. 349/65; 362/608

(57) ABSTRACT

A backlight module includes: a light guide plate including a light-entering surface; a light source module disposed beside the light-entering surface; and a reflector including an opening adjacent to the light-entering surface. The light source module is disposed in the reflector and emits light toward the light-entering surface through the opening. A height of the opening is less than a thickness of the light guide plate.

### RELATED APPLICATIONS

The present application is based on, and claims priority from, Taiwan Application Number 97146820 filed Dec. 2, 2008, the disclosure of which is hereby incorporated by reference herein in its entirety.

### TECHNICAL FIELD

The present disclosure relates to a backlight module, and more particularly to a backlight module, which can effectively mitigate the hot spot phenomenon, and its application on a liquid crystal display.

### BACKGROUND

FIG. 1A is a cross-sectional view of a portion of a conventional backlight module. A backlight module 100 mainly includes a light guide plate 102, a light-emitting diode light source module 106 and a reflector 116. The light-emitting diode light source module 106 is disposed beside a side of the light guide plate 102, the reflector 116 is disposed around an outer side of the light-emitting diode light source module 106, and the reflector 116 and the light guide plate 102 collectively ring the light-emitting diode light source module 106. The reflector 116 is composed of three side plates 118, 120 and 122, wherein the side plates 118 and 120 are respectively connected to two opposite ends of the side plate 122 and are opposite to each other. The light-emitting diode light source module 106 mainly includes a circuit board 110 and a plurality of light-emitting diodes 108, wherein the light-emitting diodes 108 are disposed on a surface of the circuit board 110. In the light-emitting diode light source module 106, each light-emitting diode 108 includes a light-extracting surface 112. A side of the light guide plate 102 adjacent to the light-emitting diode light source module 106 has a light-entering surface 104.

In the backlight module 100, the light-emitting diode light source module 106 is disposed in the space defined by the side plates 118, 120 and 122, and the circuit board 110 is adhered to the side plate 118 of the reflector 116. The light guide plate 102 is disposed on the circuit board 110 of the light-emitting diode light source module 106, wherein the light-entering surface 104 of the light guide plate 102 faces the light-extracting surfaces 112 of the light-emitting diodes 108, and the light-extracting surfaces 112 of the light-emitting diodes 108 are closely against the light-entering surface 104 of the light guide plate 102, such as shown in FIG. 1A.

However, referring to FIG. 1B, the light-emitting diodes 108 are point light sources, so that in the backlight module, regions near the light-emitting diodes 108 are brighter and regions between two light-emitting diodes 108 are darker. Such phenomenon is typically referred as hot spot mura 114. The hot spot mura 114 decreases the uniformity of the light source provided by the backlight module 100 and reduces the display quality.

With regard to the hot spot phenomenon, a common solution is to use a light mask or a frame to mask the region with uneven bright. However, such solution increases the width of the edge region between the visible region and the edge of the backlight module, so it is adverse for the miniaturization of the backlight module.

Another solution for the hot spot phenomenon is to reduce the pitch of the light-emitting diodes of the light-emitting diode light source module by increasing the density of the light-emitting diodes to improve the hot spot mura. However, the method of decreasing the pitch of the light-emitting diodes increases the cost of the backlight module, so the method is not a good solution.

### SUMMARY

Therefore, one aspect of the present disclosure is to provide a backlight module, which can limit light-extracting angles toward an upper direction and a lower direction of a light-emitting diode to control the angle of light, which is emitted by the light-emitting diode, entering the light guide plate. Therefore, the light can go forward toward the center of the visible region and then is extracted from the light-extracting surface of the light guide plate, thereby can effectively decrease or even eliminate the hot spot mura at the light-entering area of the light guide plate.

Another aspect of the present disclosure is to provide a backlight module, in which the hot spot phenomenon can be greatly improved or eliminated, so that a pitch of light-emitting diodes of a light-emitting diode light source module can be increased, the amount of the light-emitting diodes can be decreased, and an edge region of the backlight module can be reduced.

Still another aspect of the present disclosure is to provide a liquid crystal display, which can reduce or eliminate the hot spot mura of a backlight module while the size specification of the display is kept. Therefore, the display quality of the liquid crystal display can be effectively enhanced under the original size specification.

According to one or more embodiments, a backlight module includes: a light guide plate including a light-entering surface; a light source module disposed beside the light-entering surface; and a reflector including an opening adjacent to the light-entering surface, wherein the light-emitting diode light source module is disposed in the reflector for emitting light toward the light-entering surface through the opening, and a height of the opening is less than a thickness of the light guide plate.

According to one or more embodiments, a liquid crystal display includes a liquid crystal display panel and a backlight module disposed at a rear surface of the liquid crystal display panel. The backlight module includes: a light guide plate including a light-entering surface; a light source module disposed beside the light-entering surface; and a reflector including an opening adjacent to the light-entering surface. The light source module is disposed in the reflector for emitting light toward the light-entering surface through the opening. A height of the opening is less than a thickness of the light guide plate.

### BRIEF DESCRIPTION OF THE DRAWINGS

FIG. 1A is a cross-sectional view of a portion of a conventional backlight module;

FIG. 1B is a top view of a conventional backlight module;

FIG. 2A is a cross-sectional view of a portion of a backlight module in accordance with a first embodiment;

FIG. 2B is a cross-sectional view of a portion of a backlight module in accordance with a second embodiment;

FIG. 2C is a cross-sectional view of a portion of a backlight module in accordance with a third embodiment;

FIG. 2D is a cross-sectional view of a portion of a backlight module in accordance with a fourth embodiment;

FIG. 3A is a brightness distribution curve obtained when a distance between light-extracting surfaces of light-emitting diodes and a light-entering surface of a light guide plate is 1 mm, the thickness of the light guide plate is 4 mm and the height of an opening of a reflector is 4 mm;

FIG. 3B is a brightness distribution curve obtained when a distance between light-extracting surfaces of light-emitting diodes and a light-entering surface of a light guide plate is 1 mm, the thickness of the light guide plate is 4 mm and the height of an opening of a reflector is 3.8 mm;

FIG. 3C is a brightness distribution curve obtained when a distance between light-extracting surfaces of light-emitting diodes and a light-entering surface of a light guide plate is 1 mm, the thickness of the light guide plate is 4 mm and the height of an opening of a reflector is 3.6 mm;

FIG. 3D is a brightness distribution curve obtained when a distance between light-extracting surfaces of light-emitting diodes and a light-entering surface of a light guide plate is 1 mm, the thickness of the light guide plate is 4 mm and the height of an opening of a reflector is 3 mm;

FIG. 3E is a brightness distribution curve obtained when a distance between light-extracting surfaces of light-emitting diodes and a light-entering surface of a light guide plate is 1 mm, the thickness of the light guide plate is 4 mm and the height of an opening of a reflector is 2.4 mm;

FIG. 4A is a brightness distribution curve obtained when the thickness of the light guide plate is 4 mm, the height of an opening of a reflector is 3.6 mm and a distance between light-extracting surfaces of light-emitting diodes and a light-entering surface of a light guide plate is 1 mm;

FIG. 4B is a brightness distribution curve obtained when the thickness of the light guide plate is 4 mm, the height of an opening of a reflector is 3.6 mm and a distance between light-extracting surfaces of light-emitting diodes and a light-entering surface of a light guide plate is 1.5 mm;

FIG. 4C is a brightness distribution curve obtained when the thickness of the light guide plate is 4 mm, the height of an opening of a reflector is 3.6 mm and a distance between light-extracting surfaces of light-emitting diodes and a light-entering surface of a light guide plate is 1.08 mm;

FIG. 4D is a brightness distribution curve obtained when the thickness of the light guide plate is 4 mm, the height of an opening of a reflector is 3 mm and a distance between light-extracting surfaces of light-emitting diodes and a light-entering surface of a light guide plate is 1 mm;

FIG. 4E is a brightness distribution curve obtained when the thickness of the light guide plate is 4 mm, the height of an opening of a reflector is 3 mm and a distance between light-extracting surfaces of light-emitting diodes and a light-entering surface of a light guide plate is 1.5 mm;

FIG. 4F is a brightness distribution curve obtained when the thickness of the light guide plate is 4 mm, the height of an opening of a reflector is 2.4 mm and a distance between light-extracting surfaces of light-emitting diodes and a light-entering surface of a light guide plate is 1 mm;

FIG. 4G is a brightness distribution curve obtained when the thickness of the light guide plate is 4 mm, the height of an opening of a reflector is 2.4 mm and a distance between light-extracting surfaces of light-emitting diodes and a light-entering surface of a light guide plate is 1.5 mm;

FIG. 4H is a brightness distribution curve obtained when the thickness of the light guide plate is 4 mm, the height of an opening of a reflector is 1.8 mm and a distance between light-extracting surfaces of light-emitting diodes and a light-entering surface of a light guide plate is 0.9 mm; and

FIG. 5 is a cross-sectional view of a portion of a liquid crystal display in accordance with an embodiment.

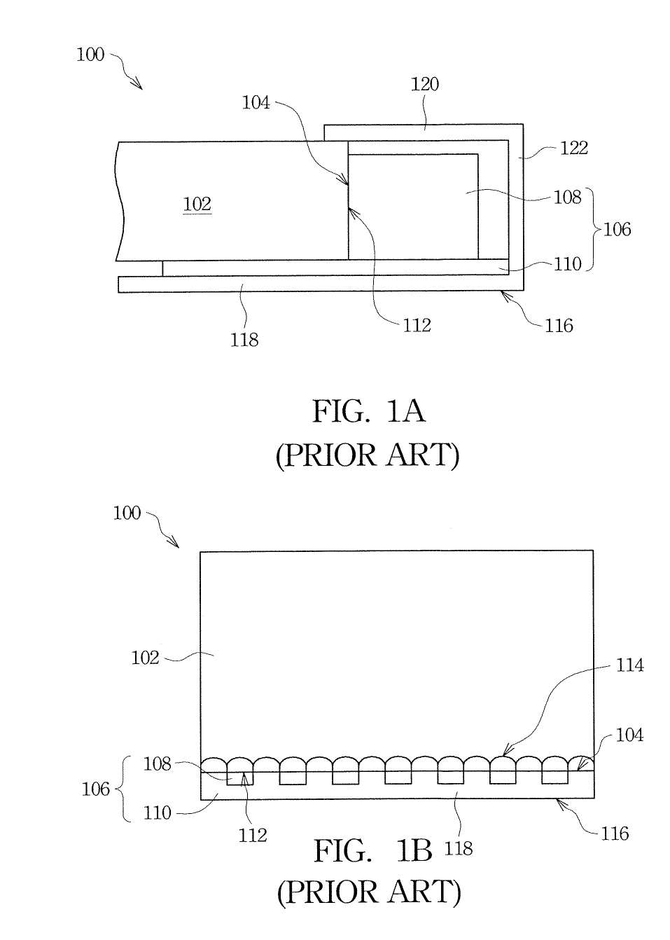

### DETAILED DESCRIPTION

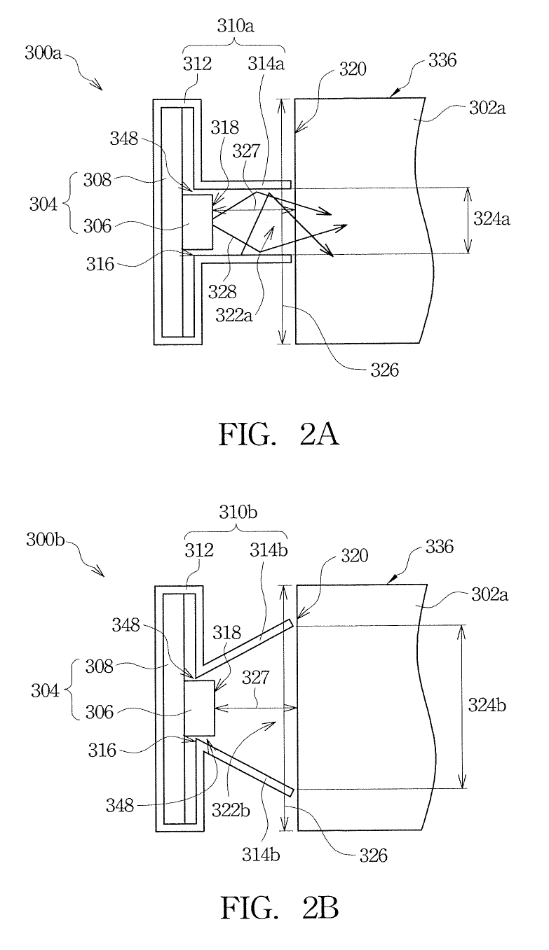

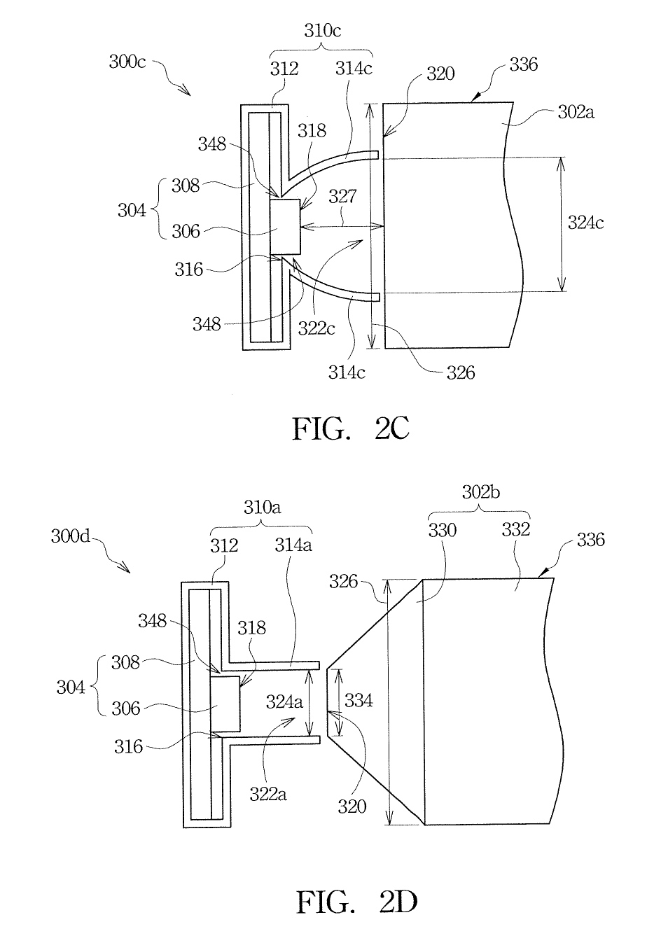

FIG. 2A is a cross-sectional view of a portion of a backlight module in accordance with a first embodiment. In one exemplary embodiment, a backlight module 300a includes a light guide plate 302a, a light-emitting diode light source module 304 and a reflector 310a. One side of the light guide plate 302a includes a light-entering surface 320, and another side adjacent to the side of the light guide plate 302a includes a light-extracting surface 336. The light-emitting diode light source module 304 is disposed in the reflector 310a, and the combination of the light-emitting diode light source module 304 and the reflector 310a is disposed beside the light-entering surface 320 of the light guide plate 302a. The light guide plate 302a has a thickness 326. In one embodiment, the light guide plate 302a may be, for example, a wedge plate structure or a flat plate structure. When the light guide plate 302a is a flat plate structure with a substantially uniform thickness, the thickness at the light-entering surface 320 can represent the thickness 326 of the light guide plate 302a; and when the light guide plate 302a is a wedge plate structure, the thickness 326 of the light guide plate 302a is the thickness of the thickest portion of the light guide plate 302a, which is typically the thickness at the light-entering surface 320. The light-emitting diode light source module 304 mainly includes a circuit board 308 and a plurality of light-emitting diodes 306, wherein each light-emitting diode 306 includes a light-extracting surface 318, the light-emitting diodes 306 are disposed on a surface of the circuit board 308, and the light-extracting surface 318 of each light-emitting diode 306 faces the light-entering surface 320 of the light guide plate 302a.

The reflector 310a includes a C-shaped structure 312 and two extension portions 314a, wherein the C-shaped structure 312 includes an opening 348, and the two extension portions 314a are respectively connected to two ends 316 of the opening 348 of the C-shaped structure 312. In the present exemplary embodiment, each extension portion 314a is a flat plate, and the two extension portions 314a are parallel with each other and are substantially horizontally disposed between the two ends 316 of the opening 348 of the C-shaped structure 312 and the light-entering surface 320 of the light guide plate 302a. The two extension portions 314a form an opening 322a in front of the light-entering surface 320 of the light guide plate 302a, i.e., the opening 322a of the reflector 310a is adjacent to the light-entering surface 320 of the light guide plate 302a. Accordingly, the light-emitting diode light source module 304 can emit light toward the light-entering surface 320 of the light guide plate 302a through the opening 322a. The distance from the opening 322a of the reflector 310a to the light-entering surface 320 of the light guide plate 302a is fixed, and the reflector 310a preferably contacts with the light-entering surface 320 of the light guide plate 302a. The circuit board 308 of the light-emitting diode light source module 304 is contained in the C-shaped structure 312 of the reflector 310a, and the light-extracting surface 318 of each light-emitting diode 306 is preferably between the two extension portions 314a. The light-extracting surface 318 of each light-emitting diode 306 is separated from the light-entering surface 320 of the light guide plate 302a by a distance 327. With the reflection and the guide of the reflector 310a, the light 328 emitted from the light-extracting surface 318 of the light-emitting diode 306 can be guided to the light-entering surface 320 in front of the opening 322a to enter the light guide plate 302a.

In the present exemplary embodiment, a height 324a of the opening 322a of the reflector 310a is smaller than the thickness 326 of the light guide plate 302a, such as shown in FIG. 2A. In one embodiment, when the thickness 326 of the light guide plate 302a is about 4 mm, the height 324a of the opening 322a of the reflector 310a is preferably between about 3.0 mm and about 3.8 mm. Therefore, the height 324a of the opening 322a of the reflector 310a is preferably between substantially three-fourth and substantially nineteen-twentieth of the thickness 326 of the light guide plate 302a. A distance between reflection surfaces in an upper direction and a lower direction of the light-emitting diode 306 can be decreased by reducing the height 324a of the opening 322a of the reflector 310a. Therefore, light-extracting angles toward the upper direction and the lower direction of the light-emitting diode 306 can be limited to control an angle of light 328, which is emitted by the light-emitting diode 306, entering the light guide plate 302a within an appropriate range, so as to reduce the brightness of the light guide plate 302a right in front of the light-emitting diode 306 to effectively solve the hot spot problem of the backlight module 300a. The smaller the height 324a of the opening 322a of the reflector 310a is, the lighter the hot spot mura of the backlight module 300a is, and the shorter the distance 327 between the light-extracting surface 318 of the light-emitting diode 306 and the light-entering surface 320 of the light guide plate 302a is. But, the bright line situation of the light guide plate 302a is clearer. In one exemplary embodiment, a ratio of the distance 327 between the light-extracting surface 318 of the light-emitting diode 306 and the light-entering surface 320 of the light guide plate 302a to the height 324a of the opening 322a of the reflector 310a is preferably greater than or equal to 30%.

The reflector may have other different configurations. FIG. 2B is a cross-sectional view of a portion of a backlight module in accordance with a second embodiment. In the present exemplary embodiment, the configuration of a backlight module 300b is approximately the same as that of the backlight module 300a of the first embodiment, and the difference between the backlight module 300a and 300b is only that the structural configuration of a reflector 310b of the backlight module 300b is different from that of the reflector 310a of the backlight module 300a. In the backlight module 300b, the reflector 310b mainly includes a C-shaped structure 312 and two extension portions 314b, wherein the two extension portions 314b are respectively connected to two ends 316 of an opening 348 of the C-shaped structure 312, and each extension portion 314b is a flat plate. In the present exemplary embodiment, the two extension portions 314b incline outward respectively from the two ends 316 of the opening 348 of the C-shaped structure 312 toward the light-entering surface 320 of the light guide plate 302a, and are disposed between the two ends 316 of the opening 348 of the C-shaped structure 312 and the light-entering surface 320 of the light guide plate 302a, so as to form an opening 322b in front of the light-entering surface 320 of the light guide plate 302a. Therefore, the light-emitting diode light source module 304 can emit light toward the light-entering surface 320 of the light guide plate 302a through the opening 322b of the reflector 310b. The distance from the opening 322b of the reflector 310b to the light-entering surface 320 of the light guide plate 302a is fixed, and the reflector 310b preferably contacts with the light-entering surface 320 of the light guide plate 302a. In another embodiment, the two extension portions of the reflector may incline inward respectively from the two ends of the opening of the C-shaped structure of the reflector toward the light-entering surface 320 of the light guide plate 302a, and are disposed between the two ends of the opening of the C-shaped structure and the light-entering surface 320 of the light guide plate 302a. Similarly, the circuit board 308 of the light-emitting diode light source module 304 is contained in the C-shaped structure 312 of the reflector 310b, and the light-extracting surface 318 of each light-emitting diode 306 is preferably between the two extension portions 314b.

In the present exemplary embodiment, a height 324b of the opening 322b of the reflector 310b is smaller than the thickness 326 of the light guide plate 302a, such as shown in FIG. 2B. In one embodiment, the height 324b of the opening 322b of the reflector 310b is preferably between substantially three-fourth and substantially nineteen-twentieth of the thickness 326 of the light guide plate 302a. In one exemplary embodiment, a ratio of the distance 327 between the light-extracting surface 318 of the light-emitting diode 306 and the light-entering surface 320 of the light guide plate 302a to the height 324b of the opening 322b of the reflector 310b is preferably greater than or equal to 30%.

FIG. 2C is a cross-sectional view of a portion of a backlight module in accordance with a third embodiment. In the present exemplary embodiment, the configuration of a backlight module 300c is approximately the same as that of the backlight module 300a of the first embodiment, and the difference between the backlight module 300a and 300c is that the structural configuration of a reflector 310c of the backlight module 300c is different from that of the reflector 310a of the backlight module 300a. In the backlight module 300c, the reflector 310c mainly includes a C-shaped structure 312 and two extension portions 314c, wherein the two extension portions 314c are respectively connected to two ends 316 of an opening 348 of the C-shaped structure 312, and each extension portion 314c is a curved plate not a flat plate. In the present exemplary embodiment, the two extension portions 314c respectively extend from the two ends 316 of the opening 348 of the C-shaped structure 312 and are disposed between the two ends 316 of the opening 348 of the C-shaped structure 312 and the light-entering surface 320 of the light guide plate 302a, so as to form an opening 322c in front of the light-entering surface 320 of the light guide plate 302a. Therefore, the light-emitting diode light source module 304 can emit light toward the light-entering surface 320 of the light guide plate 302a through the opening 322c of the reflector 310c. The distance from the opening 322c of the reflector 310c to the light-entering surface 320 of the light guide plate 302a is fixed, and the reflector 310c preferably contacts with the light-entering surface 320 of the light guide plate 302a. Similarly, the circuit board 308 of the light-emitting diode light source module 304 is contained in the C-shaped structure 312 of the reflector 310c, and the light-extracting surface 318 of each light-emitting diode 306 is preferably between the two extension portions 314c.

In the present exemplary embodiment, a height 324c of the opening 322c of the reflector 310c is smaller than the thickness 326 of the light guide plate 302a, such as shown in FIG. 2C. In one embodiment, the height 324c of the opening 322c of the reflector 310c is preferably between substantially three-fourth and substantially nineteen-twentieth of the thickness 326 of the light guide plate 302a. In one exemplary embodiment, a ratio of the distance 327 between the light-extracting surface 318 of the light-emitting diode 306 and the light-entering surface 320 of the light guide plate 302a to the height 324c of the opening 322c of the reflector 310c is preferably greater than or equal to 30%.

FIG. 2D is a cross-sectional view of a portion of a backlight module in accordance with a fourth embodiment. In the present exemplary embodiment, the configuration of a backlight module 300d is approximately the same as that of the backlight module 300a of the first embodiment, and the difference between the backlight module 300a and 300d is that the structural configuration of a light guide plate 302b is different from that of the light guide plate 302a. In the backlight module 300d, the light guide plate 302b is composed a chamfer region 330 and a non-chamfer region 332 connected with each other. The chamfer region 330 is adjacent to the light-emitting diode light source module 304 and the reflector 310a, and the light-entering surface 320 of the light guide plate 302b is located on a side of the chamfer region 330 adjacent to the opening 322a. In the present exemplary embodiment, the non-chamfer region 332 may be a flat plate structure or a wedge plate structure. Therefore, the thickness 326 of the light guide plate 302b is equal to the thickness at the non-chamfer region 332.

In the present exemplary embodiment, a height 324a of the opening 322a of the reflector 310a is smaller than or equal to a height 334 of the light-entering surface 320 on the chamfer region 330 of the light guide plate 302b adjacent to the opening 322a of the reflector 310a, such as shown in FIG. 2D. In one embodiment, the height 324a of the opening 322a of the reflector 310a is smaller than the thickness 326 of the light guide plate 302b. In one embodiment, the height 324a of the opening 322a of the reflector 310a is preferably between substantially three-fourth and substantially nineteen-twentieth of the thickness 326 of the light guide plate 302b. The distance from the opening 322a of the reflector 310a to the light-entering surface 320 of the light guide plate 302b is fixed, and the reflector 310a preferably touches the light-entering surface 320 of the chamfer region 330.

In the backlight module 300d of the fourth embodiment, the light guide plate 302b is applied with the reflector 310a of the first embodiment. However, the reflector 310a used in the backlight module 300d can be replaced by the reflectors in the other embodiments, such as the reflector 310b and its variation and reflector 310c.

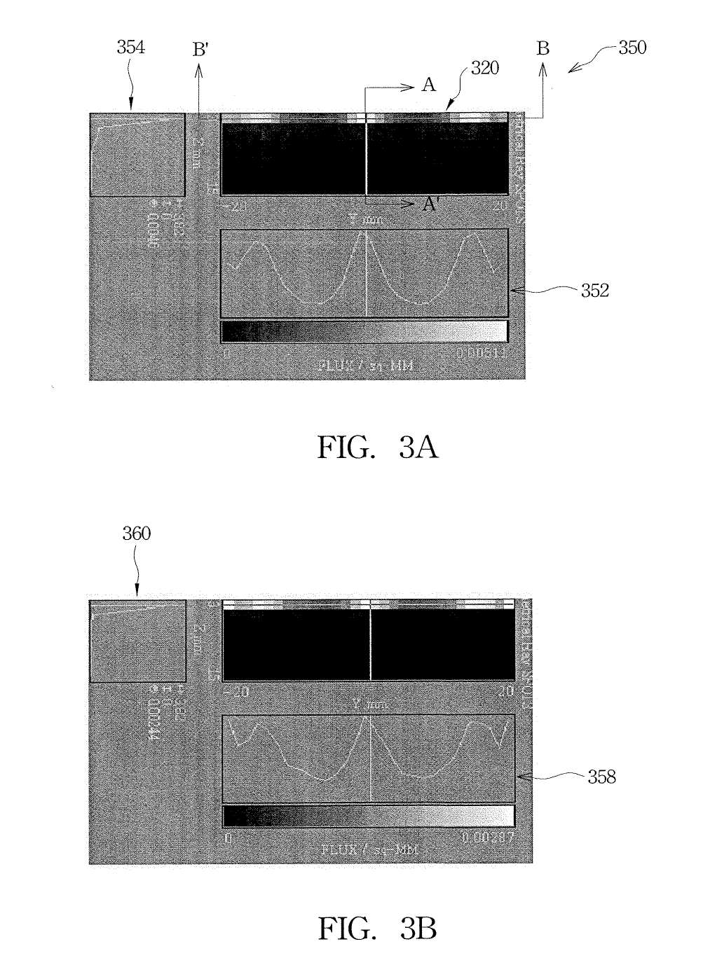

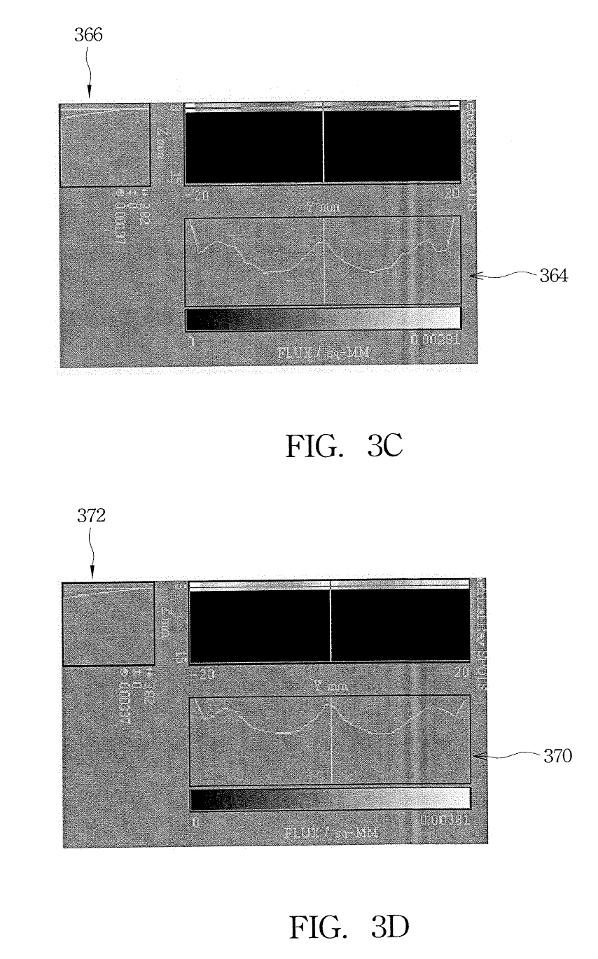

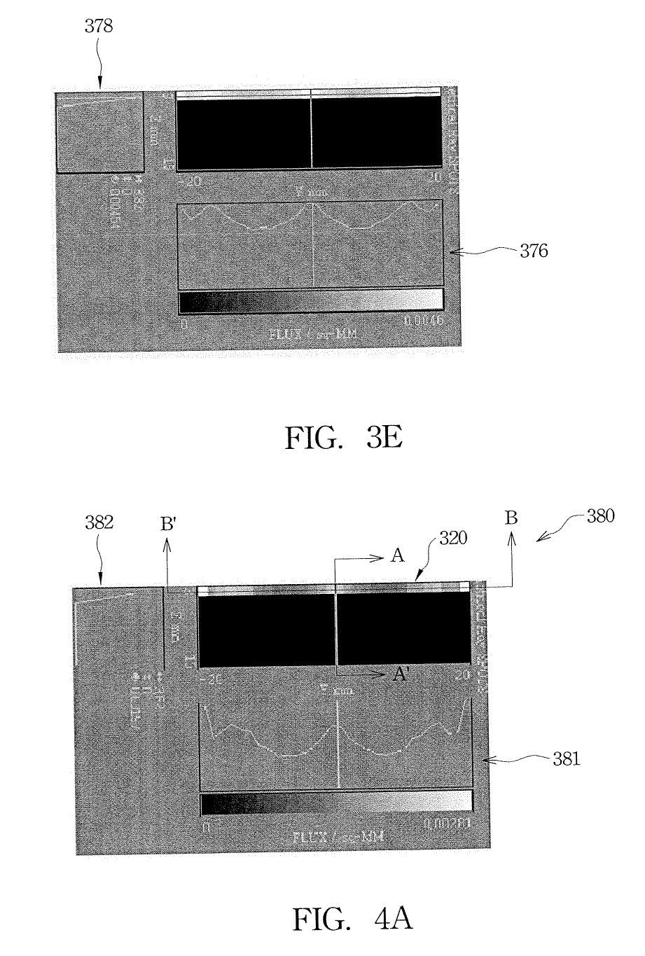

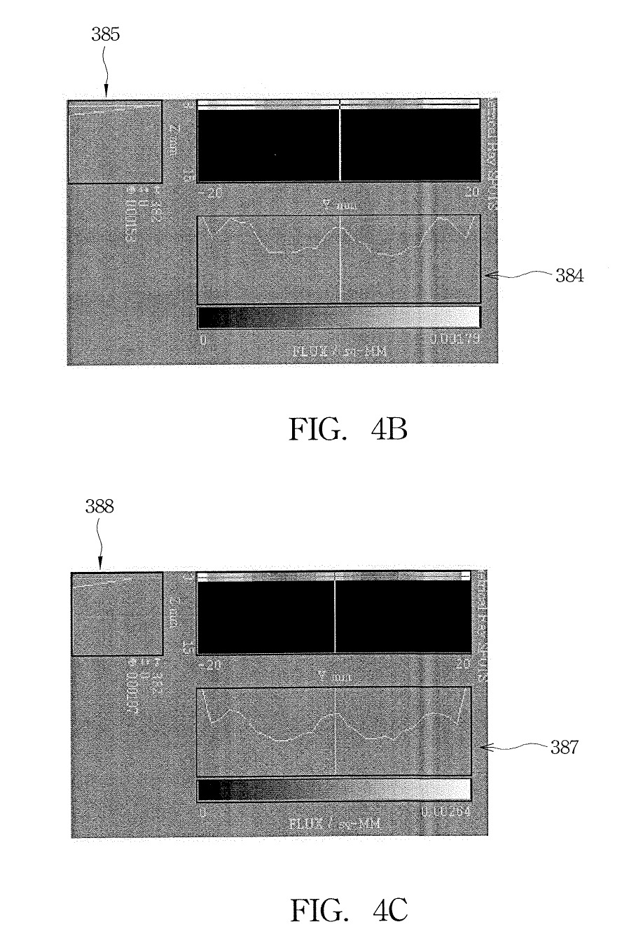

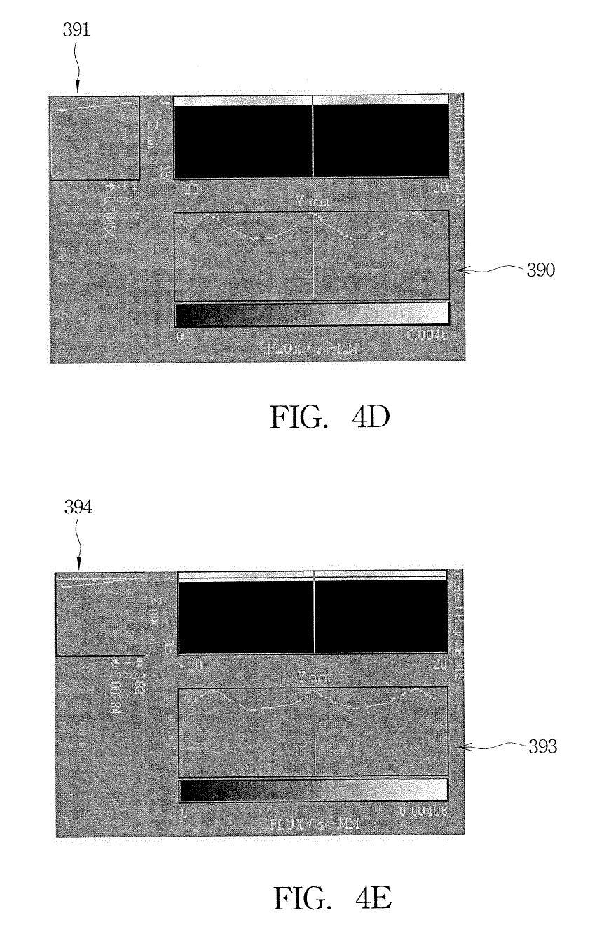

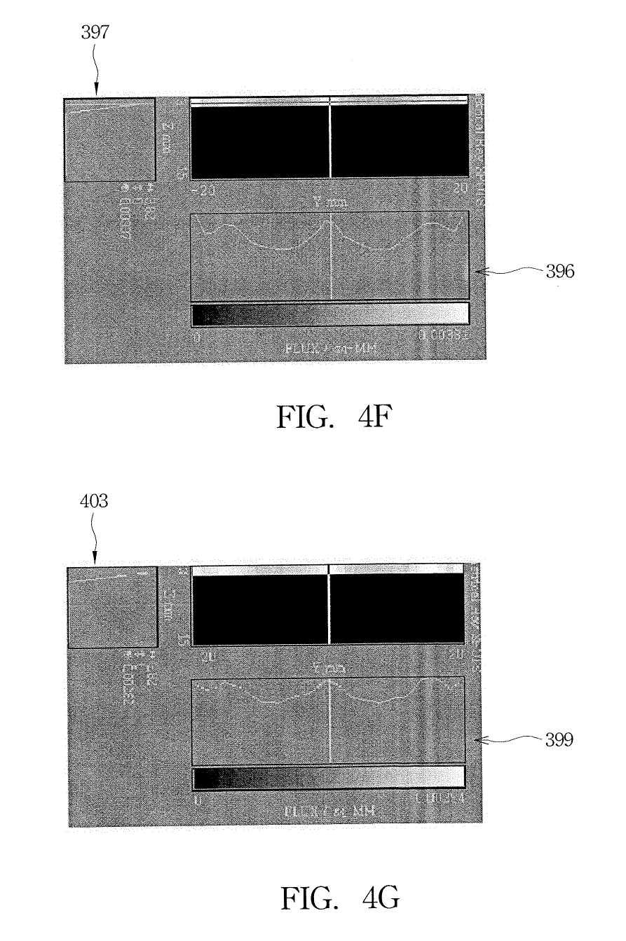

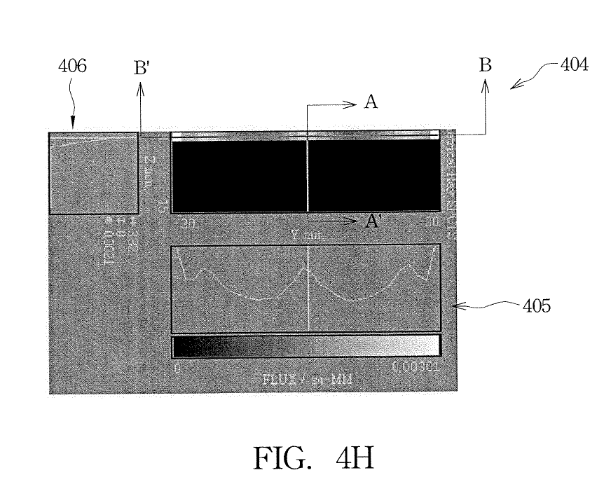

FIG. 3A through FIG. 4H are schematic diagrams showing the simulation results by using three light-emitting diodes as the light source. FIG. 3A is a brightness distribution curve obtained when the distance 327 between the light-extracting surfaces of the light-emitting diodes and the light-entering surface of the light guide plate is 1 mm, the thickness 326 of the light guide plate is 4 mm and the height of the opening 324a of the reflector is 4 mm. The diagram 350 shown in FIG. 3A is a brightness distribution curve of the light-extracting surface 336 of the light guide plate, wherein an top edge of the diagram 350 is the light-entering surface 320, a diagram 352 is a brightness distribution curve obtained along a transverse axle BB′ of the diagram 350, and a diagram 354 is a brightness distribution curve obtained along a lengthwise axle AA′ of the diagram 350. In FIG. 3A, when the thickness of the light guide plate is 4 mm, and the height of the opening of the reflector is 4 mm, the diagram 352 shows that the transverse brightness distribution curve of the light guide plate has obvious undulation, so the hot spot is clear under such condition. Furthermore, the lengthwise brightness distribution curve of the diagram 354 shows that the brightness distribution is uniform when the interior of the light guide plate is away from the light-entering surface with a certain distance, so the range of the invisible region of the light guide plate is larger.

FIG. 3B is a brightness distribution curve obtained when the distance 327 between the light-extracting surfaces of the light-emitting diodes and the light-entering surface of the light guide plate is 1 mm, the thickness 326 of the light guide plate is 4 mm and the height of the opening 324a of the reflector is 3.8 mm. In FIG. 3B, when the thickness of the light guide plate is 4 mm, and the height of the opening of the reflector is reduced to 3.8 mm, the diagram 358 shows that the transverse brightness distribution curve of the light guide plate has tended to gradualness, so the hot spot phenomenon at the invisible region has been effectively improved under such condition. In addition, the lengthwise brightness distribution curve of the diagram 360 shows that the range of the invisible region of the light guide plate is decreased as the height of the opening of the reflector is reduced.

FIG. 3C is a brightness distribution curve obtained when the distance 327 between the light-extracting surfaces of the light-emitting diodes and the light-entering surface of the light guide plate is 1 mm, the thickness 326 of the light guide plate is 4 mm and the height of the opening 324a of the reflector is 3.6 mm. In FIG. 3C, when the thickness of the light guide plate is 4 mm, and the height of the opening of the reflector is reduced to 3.6 mm, the diagram 364 shows that the transverse brightness distribution curve of the light guide plate is more gradual than that when the height of the opening of the reflector is 3.8 mm. However, under such condition, a bright line is formed on the light guide plate near the light-entering surface. In addition, the lengthwise brightness distribution curve of the diagram 366 shows that the range of the invisible region of the light guide plate is slightly smaller than that when the height of the opening of the reflector is 3.8 mm.

FIG. 3D is a brightness distribution curve obtained when the distance 327 between the light-extracting surfaces of the light-emitting diodes and the light-entering surface of the light guide plate is 1 mm, the thickness 326 of the light guide plate is 4 mm and the height of the opening 324a of the reflector is 3 mm. In FIG. 3D, when the thickness of the light guide plate is 4 mm, and the height of the opening of the reflector is reduced to 3 mm, the diagram 370 shows that the transverse brightness distribution curve of the light guide plate is more gradual than that when the height of the opening of the reflector is 3.6 mm. In addition, the lengthwise brightness distribution curve of the diagram 372 shows that the range of the invisible region of the light guide plate is slightly smaller than that when the height of the opening of the reflector is 3.6 mm. However, a clearer bright line exists in the invisible region of the light guide plate.

FIG. 3E is a brightness distribution curve obtained when the distance 327 between the light-extracting surfaces of the light-emitting diodes and the light-entering surface of the light guide plate is 1 mm, the thickness 326 of the light guide plate is 4 mm and the height of the opening 324a of the reflector is 2.4 mm. In FIG. 3E, when the thickness of the light guide plate is 4 mm, and the height of the opening of the reflector is reduced to 2.4 mm, diagram 376 shows that the transverse brightness distribution curve of the light guide plate is more gradual than that when the height of the opening of the reflector is 3 mm. In addition, the lengthwise brightness distribution curve of the diagram 378 shows that the range of the invisible region of the light guide plate is slightly smaller than that when the height of the opening of the reflector is 3 mm. However, a further clearer bright line exists in the invisible region of the light guide plate.

FIG. 4A is a brightness distribution curve obtained when the thickness 326 of the light guide plate is 4 mm, the height of the opening 324a of the reflector is 3.6 mm and the distance 327 between the light-extracting surfaces of the light-emitting diodes and the light-entering surface of the light guide plate is 1 mm. A diagram 380 shown in FIG. 4A is a brightness distribution curve of the light-extracting surface 336 of the light guide plate, wherein an top edge of the diagram 380 is the light-entering surface 320, a diagram 381 is a brightness distribution curve obtained along a transverse axle BB′ of the diagram 380, and a diagram 382 is a brightness distribution curve obtained along a lengthwise axle AA′ of the diagram 380. The distance between the light-extracting surfaces of the light-emitting diodes and the light-entering surface of the light guide plate is 1 mm, and the height of the opening of the reflector is 3.6 mm, so that the ratio of the distance to the height of the opening is equal to about 27.8%. In FIG. 4A, diagram 381 shows that the transverse brightness distribution curve of the light guide plate is more gradual, so the hot spot phenomenon in the invisible region is improved. The lengthwise brightness distribution curve of the diagram 382 shows that the range of the invisible region of the light guide plate is decreased as the height of the opening of the reflector is reduced.

FIG. 4B is a brightness distribution curve obtained when the thickness 326 of the light guide plate is 4 mm, the height of the opening 324a of the reflector is 3.6 mm and the distance 327 between the light-extracting surfaces of the light-emitting diodes and the light-entering surface of the light guide plate is 1.5 mm. A diagram 385 is a lengthwise brightness distribution curve of the light-extracting surface 336 of the light guide plate. The distance between the light-extracting surfaces of the light-emitting diodes and the light-entering surface of the light guide plate is 1.5 mm, and the height of the opening of the reflector is 3.6 mm, so that the ratio of the distance to the height of the opening is equal to about 41.67%. In FIG. 4B, diagram 384 shows that the transverse brightness distribution curve of the light guide plate is more gradual than that when the distance is 1 mm, so the hot spot phenomenon in the invisible region is further improved.

FIG. 4C is a brightness distribution curve obtained when the thickness 326 of the light guide plate is 4 mm, the height of the opening 324a of the reflector is 3.6 mm and the distance 327 between the light-extracting surfaces of the light-emitting diodes and the light-entering surface of the light guide plate is 1.08 mm. A diagram 388 is a lengthwise brightness distribution curve of the light-extracting surface 336 of the light guide plate. The distance between the light-extracting surfaces of the light-emitting diodes and the light-entering surface of the light guide plate is 1.08 mm, and the height of the opening of the reflector is 3.6 mm, so that the ratio of the distance to the height of the opening is increased to about 30%. In FIG. 4C, diagram 387 shows that the transverse brightness distribution curve of the light guide plate is more gradual than that when the distance is 1 mm, but is more is more undulate than that when the distance is 1.5 mm, so the hot spot phenomenon in the invisible region is improved compared to that when the distance is 1 mm, but is more obvious compared to that when the distance is 1.5 mm.

FIG. 4D is a brightness distribution curve obtained when the thickness 326 of the light guide plate is 4 mm, the height of the opening 324a of the reflector is 3 mm and the distance 327 between the light-extracting surfaces of the light-emitting diodes and the light-entering surface of the light guide plate is 1 mm. A diagram 391 is a lengthwise brightness distribution curve of the light-extracting surface 336 of the light guide plate. The distance between the light-extracting surfaces of the light-emitting diodes and the light-entering surface of the light guide plate is 1 mm, and the height of the opening of the reflector is reduced to 3 mm, so that the ratio of the distance to the height of the opening is increased to about 33.33%. In FIG. 4D, diagram 390 shows that the transverse brightness distribution curve of the light guide plate is more gradual than that when the distance is 1 mm and the height of the opening of the reflector is 3.6 mm, so the hot spot phenomenon in the invisible region is improved compared to that when the height of the opening of the reflector is 3.6 mm.

FIG. 4E is a brightness distribution curve obtained when the thickness 326 of the light guide plate is 4 mm, the height of the opening 324a of the reflector is 3 mm and the distance 327 between the light-extracting surfaces of the light-emitting diodes and the light-entering surface of the light guide plate is 1.5 mm. A diagram 394 is a lengthwise brightness distribution curve of the light-extracting surface 336 of the light guide plate. The distance between the light-extracting surfaces of the light-emitting diodes and the light-entering surface of the light guide plate is increased to 1.5 mm, and the height of the opening of the reflector is still 3 mm, so that the ratio of the distance to the height of the opening is increased to about 50%. In FIG. 4E, diagram 393 shows that the transverse brightness distribution curve of the light guide plate is more gradual than that when the distance is 1 mm, so the hot spot phenomenon in the invisible region is improved compared to that when the distance is 1 mm.

FIG. 4F is a brightness distribution curve obtained when the thickness 326 of the light guide plate is 4 mm, the height of the opening 324a of the reflector is 2.4 mm and the distance 327 between the light-extracting surfaces of the light-emitting diodes and the light-entering surface of the light guide plate is 1 mm. The distance between the light-extracting surfaces of the light-emitting diodes and the light-entering surface of the light guide plate is 1 mm, and the height of the opening of the reflector is reduced to 2.4 mm, so that the ratio of the distance to the height of the opening is increased to about 41.67%. In FIG. 4F, diagram 396 shows that the transverse brightness distribution curve of the light guide plate is more gradual than that when the distance is 1 mm and the height of the opening of the reflector is 3 mm, so the hot spot phenomenon in the invisible region is improved compared to that when the height of the opening of the reflector is 3 mm. In addition, the lengthwise brightness distribution curve of a diagram 397 shows that the brightness of the invisible region of the light guide plate is larger than that when the height of the opening of the reflector, so the bright line phenomenon is more obvious.

FIG. 4G is a brightness distribution curve obtained when the thickness 326 of the light guide plate is 4 mm, the height of the opening 324a of the reflector is 2.4 mm and the distance 327 between the light-extracting surfaces of the light-emitting diodes and the light-entering surface of the light guide plate is 1.5 mm. A diagram 403 is a lengthwise brightness distribution curve of the light-extracting surface 336 of the light guide plate. The distance between the light-extracting surfaces of the light-emitting diodes and the light-entering surface of the light guide plate is increased to 1.5 mm, and the height of the opening of the reflector is still 2.4 mm, so that the ratio of the distance to the height of the opening is increased to about 62.5%. In FIG. 4G, diagram 399 shows that the transverse brightness distribution curve of the light guide plate is more gradual than that when the distance is 1 mm, so the hot spot phenomenon in the invisible region is improved compared to that when the distance is 1 mm.

FIG. 4H is a brightness distribution curve obtained when the thickness 326 of the light guide plate is 4 mm, the height of the opening 324a of the reflector is 1.8 mm and the distance 327 between the light-extracting surfaces of the light-emitting diodes and the light-entering surface of the light guide plate is 0.9 mm. Diagram 404 is a lengthwise brightness distribution curve of the light-extracting surface 336 of the light guide plate, and a diagram 405 is a brightness distribution curve obtained along a transverse axle BB′ of the diagram 404, and a diagram 406 is a brightness distribution curve obtained along a lengthwise axle AA′ of the diagram 404. The distance between the light-extracting surfaces of the light-emitting diodes and the light-entering surface of the light guide plate is decreased to 0.9 mm, and the height of the opening of the reflector is further reduced to 1.8 mm, so that the ratio of the distance to the height of the opening is increased to about 50%. In FIG. 4H, the diagram 405 shows that the transverse brightness distribution curve of the light guide plate is more undulate due to the reduction of the distance. The lengthwise brightness distribution curve of the diagram 406 shows that although the distance is decreased, the range of the invisible region of the light guide plate is decreased due to the opening of the reflector is reduced.

It is noted from FIG. 4A through FIG. 4H that as the opening of the reflector is getting smaller, the hot spot phenomenon becomes more unobvious, and the distance between the light-extracting surfaces of the light-emitting diodes and the light-entering surface of the light guide plate can be shorter. However, as the opening of the reflector is getting smaller, the bright line in the invisible region of the light guide plate is getting more obvious.

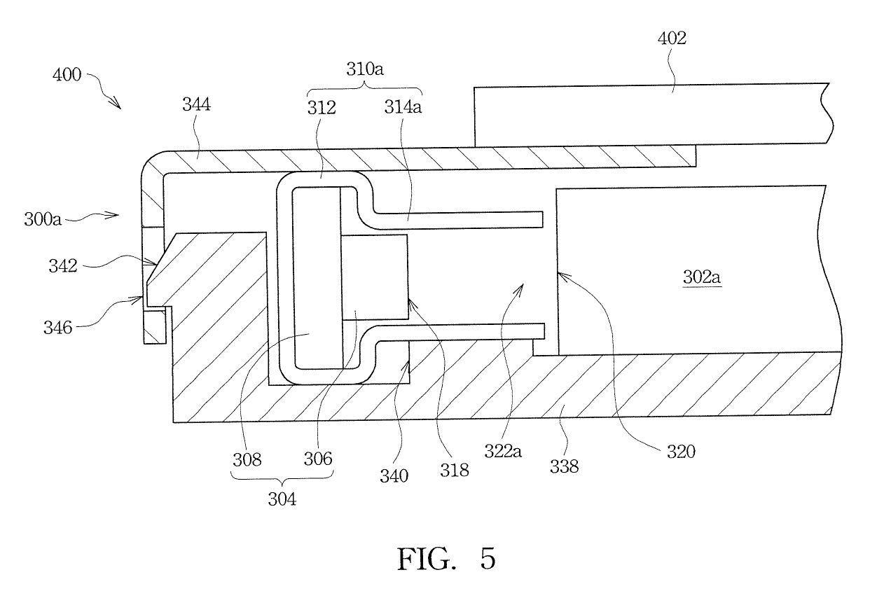

The aforementioned backlight modules can be applied in a liquid crystal display, and the backlight module 300a is adopted as an example in the following description. FIG. 5 is a cross-sectional view of a portion of a liquid crystal display in accordance with an embodiment. In one exemplary embodiment, a liquid crystal display 400 mainly includes a liquid crystal display panel 402 and a backlight module 300a, wherein the backlight module 300a is disposed on a rear surface of the liquid crystal display panel 402 to provide the liquid crystal display panel 402 with a back light source. In one embodiment, the backlight module 300a may further include a rear frame 338 and a front frame 344 to support and fix the structure of the backlight module 300a according to the product requirement. The light guide plate 302a, the light-emitting diode light source module 304 and the reflector 310a are disposed on the rear frame 338. The rear frame 338 may selectively include a fixing bump 340, wherein the fixing bump 340 blocks and is disposed between the C-shaped structure 312 of the reflector 310a and the light-entering surface 320 of the light guide plate 302a, to position the reflector 310a and the light-emitting diode light source module 304 disposed therein, and to keep the opening 322a of the reflector 310a being beside the light-entering surface 320 of the light guide plate 302a. The front frame 344 covers the edge of the light guide plate 302a, the light-emitting diode light source module 304 and the reflector 310a, and one side of the front frame 344 extends to cover an outer side surface of the reflector 310a and an outer side surface of the rear frame 338. The rear frame 338 further selectively includes a hook 342, and the front frame 344 includes a fixing hole 346 corresponding to the hook 342, wherein the hook 342 of the rear frame 338 can be wedged in the fixing hole 346 of the front frame 344. The liquid crystal display panel 402 may be disposed on the front frame 344 and is carried by the front frame.

According to one or more of the aforementioned exemplary embodiments, one advantage is that a backlight module can limit light-extracting angles toward an upper direction and a lower direction of a light-emitting diode to control an angle of light, which is emitted by the light-emitting diode, entering a light guide plate. Therefore, the light can go forward toward the center of the visible region and then is extracted from the light-extracting surface of the light guide plate, thereby can effectively decrease or even eliminate the hot spot mura at the light-entering area of the light guide plate.

According to one or more of the aforementioned exemplary embodiments, another advantage is that the hot spot phenomenon of a backlight module can be greatly improved or eliminated, so that a pitch of light-emitting diodes of a light-emitting diode light source module can be increased, the amount of the light-emitting diodes can be decreased, and an edge region of the backlight module can be reduced.

According to one or more of the aforementioned exemplary embodiments, still another advantage is that a liquid crystal display can reduce or eliminate the hot spot mura of a backlight module while the size specification of the display is kept. Therefore, the display quality of the liquid crystal display can be effectively enhanced under the original size specification.

As is understood by a person skilled in the art, the foregoing embodiments are illustrative rather than limiting. It is intended to cover various modifications and similar arrangements included within the spirit and scope of the appended claims, the scope of which should be accorded the broadest interpretation so as to encompass all such modifications and similar structure.

1. A backlight module, comprising:
a light guide plate including a light-entering surface;
a light source module disposed beside the light-entering surface; and
a reflector including an opening adjacent to the light-entering surface, wherein the light source module is disposed in the reflector for emitting light toward the light-entering surface through the opening, and a height of the opening is less than a thickness of the light guide plate.

2. The backlight module according to claim 1, wherein the height of the opening is between substantially three-fourth and substantially nineteen-twentieth of the thickness of the light guide plate.

3. The backlight module according to claim 1, wherein the reflector includes parallel extensions defining the opening.

4. The backlight module according to claim 1, wherein the light guide plate includes:
a non-chamfer region; and
a chamfer region, wherein the light-entering surface is located on a side of the chamfer region adjacent to the light source module and the reflector.

5. The backlight module according to claim 1, wherein the reflector includes extensions diverging away from the light source module and defining the opening.

6. The backlight module according to claim 1, wherein:
the light source module includes a plurality of light-emitting diodes;
each of the light-emitting diodes includes a light-extracting surface facing the opening and separated from the light-entering surface by a distance; and
a ratio of the distance to the height of the opening is greater than or equal to 30%.

7. The backlight module according to claim 6, wherein the height of the opening is between substantially three-fourth and substantially nineteen-twentieth of a thickness of the light guide plate.

8. The backlight module according to claim 6, wherein the reflector includes parallel extensions defining the opening.

9. The backlight module according to claim 6, wherein the light guide plate includes:
a non-chamfer region; and
a chamfer region, wherein the light-entering surface is located on a side of the chamfer region adjacent to the light source module and the reflector.

10. The backlight module according to claim 6, wherein the reflector includes extensions diverging away from the light source module and defining the opening.

11. A liquid crystal display, comprising:
a liquid crystal display panel; and
a backlight module disposed at a rear surface of the liquid crystal display panel, wherein the backlight module includes:
a light guide plate including a light-entering surface;
a light source module disposed beside the light-entering surface; and
a reflector including an opening adjacent to the light-entering surface, wherein the light source module is disposed in the reflector for emitting light toward the light-entering surface through the opening, and a height of the opening is less than a thickness of the light guide plate.

12. The liquid crystal display according to claim 11, wherein the height of the opening is between substantially three-fourth and substantially nineteen-twentieth of the thickness of the light guide plate.

13. The liquid crystal display according to claim 11, wherein the reflector includes parallel extensions defining the opening.

14. The liquid crystal display according to claim 11, wherein the light guide plate includes:
a non-chamfer region; and
a chamfer region, wherein the light-entering surface is located on a side of the chamfer region adjacent to the light source module and the reflector.

15. The liquid crystal display according to claim 11, wherein the reflector includes extensions diverging away from the light source module and defining the opening.

16. The liquid crystal display according to claim 11, wherein:
the light source module includes a plurality of light-emitting diodes;
each of the light-emitting diodes includes a light-extracting surface facing the opening and separated from the light-entering surface by a distance; and
a ratio of the distance to the height of the opening is greater than or equal to 30%.

17. The liquid crystal display according to claim 16, wherein the height of the opening is between substantially three-fourth and substantially nineteen-twentieth of a thickness of the light guide plate.

18. The liquid crystal display according to claim 16, wherein the reflector includes parallel extensions defining the opening.

19. The liquid crystal display according to claim 16, wherein the light guide plate includes:
a non-chamfer region; and
a chamfer region, wherein the light-entering surface is located on a side of the chamfer region adjacent to the light source module and the reflector.

20. The liquid crystal display according to claim 16, wherein the reflector includes extensions diverging away from the light source module and defining the opening.
